(19) United States
(12) Patent Application Publication
(10) Pub. No.: US 2014/0133025 A1
(43) Pub. Date: May 15, 2014

(54) STEREOSCOPIC DISPLAY DEVICE AND METHOD FOR FORMING THE SAME

(71) Applicant: Chia-Yu Lee, Shenzhen (CN)

(72) Inventor: Chia-Yu Lee, Shenzhen (CN)

(73) Assignee: Shenzhen China Star Optoelectronics Technology Co., Ltd., Shenzhen, Guangdong (CN)

(21) Appl. No.: 13/704,308

(22) PCT Filed: Nov. 8, 2012
(86) PCT No.: PCT/CN2012/084283

§ 371 Date: Dec. 14, 2012

(30) Foreign Application Priority Data
Sep. 27, 2012 (CN) 201210367113.6

(51) Int. Cl. G02B 27/26; C03C 15/00; C03C 23/00

(52) U.S. Cl. CPC G02B 27/26; C03C 23/0025; C03C 15/00
USPC 359/465; 65/62

(57) ABSTRACT

A stereoscopic display device includes a display panel, a quarter-wave plate and a glass substrate. The display panel includes left-eye pixel line units, right-eye pixel line units and a color filter which including filter units and a black matrix between any two of adjacent filter units. The quarter-wave plate includes first retarders and second retarders. The glass substrate comprises opaque areas, and each opaque area is disposed on the two adjacent first retarder and the second retarder and used for blocking the light from the right-eye pixel line units into the second retarder or the light from the left-eye pixel line units into the first retarder. Therefore, the light corresponding to the right-eye or the left-eye signals is not obscured by the opaque areas even though users watch at a large angle so that it improves crosstalk to optimize 3D image quality.

### BACKGROUND OF THE INVENTION

1. Field of the Invention

The present invention relates to a stereoscopic display device and a method for forming the same, more particularly, to a stereoscopic display device capable of suppressing crosstalk of an image and a method for forming the same.

2. Description of the Prior Art

Human beings see real-world images using both eyes. Further, the human brain forms so-called 3D images (three-dimensional images) according to differences in spatial distance between two views seen by both eyes from two different angles. A 3D display is designed to create simulations of perspectives from different angles to help users perceive 3D images when viewing 2D images.

Nowadays, 3D displays are divided into two kinds. One is auto-stereoscopic displays; the other is stereoscopic displays. Users of auto-stereoscopic displays are able to view 3D images without wearing glasses with a unique structure while ones of stereoscopic displays have to wear specially designed glasses to view 3D image.

Users wearing glasses with a unique structure to selectively receive stereoscopic images perceive stereoscopic images. The users perceive stereoscopic images by analyzing the images in brain although two eyes actually respectively receive different images. Therefore, the users identify 3D space based on the images received by the left and the right eyes. The users need the left-eye images and the right-eye images to see 3D images. In hence, the 3D images shot by at least two camera are separated and transmitted to a display, and the users with glasses see selected images through the left eye and the right eye respectively to perceive stereoscopic images.

One of the stereoscopic display using a retarder pasting on a display panel so that a user has to wear a special polarization eyeglasses to view 3D images. The retarder contains multiple zero-order wave plates and half-wave plates that are alternately arranged in a column direction. The left-eye and right-eye glasses of the polarization glasses are mounted by a pair of orthogonal polarizing filters. The left-eye and right-eye images are separated depending on orthogonal polarizing directions of light. The user with the polarization glasses acquire 3D effects by viewing the left-eye and right-eye images through the pair of orthogonal polarizing filters.

However, when observing three-dimensional images, a small portion of the left-eye images (or right-eye images) tends to enter the pathway of the viewer's right eye (or left eye). Hence, the phenomenon of crosstalk occurs. The extent of crosstalk will have a direct impact on the three-dimensional viewing effect.

### SUMMARY OF THE INVENTION

It is therefore a primary object of the present invention to provide a stereoscopic display device and a method of forming for the same to suppressing crosstalk caused by a few left-eye or right-eye images entering the right-eye or left-eye channel to improve quality of 3D images.

According to the present invention, a stereoscopic display device for displaying a 3D image comprises: a backlight module for emitting light; a display panel comprising a plurality of left-eye pixel line units, a plurality of right-eye pixel line units and a color filter, the plurality of left-eye pixel line units and the plurality of right-eye pixel line units being arranged alternately, the color filter comprising a plurality of filter units and a black matrix layer between any two of adjacent filter units; a quarter-wave plate comprising a plurality of first retarders and a plurality of second retarders, the plurality of first retarders and the plurality of second retarders being arranged alternately, an angle between an optical axis of each first retarder and an optical axis of each second retarder being 90 degrees, and a glass substrate between the display panel and the quarter-wave plate, the glass substrate comprising a plurality of opaque areas, and each opaque area onto the adjacent first retarder and the second retarder for obscuring light from the plurality of right-eye pixel line units to the plurality of second retarders or light from the plurality of left-eye pixel line units to the plurality of first retarders.

In one aspect of the present invention, each opaque area forms on a surface of the glass substrate and locates at one side of the glass substrate close to the quarter-wave plate. In another aspect of the present invention, a width of each opaque area is larger than that of the black matrix layer.

In another aspect of the present invention, each opaque area is within the glass substrate and couples to one of the plurality of black matrix layers.

In still another aspect of the present invention, a width of each opaque area is narrower than that of the plurality of black matrix layers.

In yet another aspect of the present invention, the stereoscopic display device further comprises a polarizing plate, pasting on the display panel, for polarizing the light from the backlight module to a linearly polarized light.

According to the present invention, a method of forming a stereoscopic display device comprises: providing a quarter-wave plate and a display panel, the quarter-wave plate comprising a plurality of first retarders and a plurality of second retarders. The plurality of first retarders and the plurality of second retarders being arranged alternately, an angle between an optical axis of each first retarder and that of each second retarder is 90 degrees, the display panel comprising a plurality of left-eye pixel line units, a plurality of right-eye pixel line units and a color filter, the plurality of left-eye pixel line units and the plurality of right-eye pixel line units arranging alternately, the color filter comprising a plurality of filter units and a black matrix layer between any two of adjacent filter units; forming a plurality of opaque areas on a glass substrate; and sandwiching the glass substrate between the quarter-wave plate and the display panel, each opaque area being disposed onto the adjacent first retarder and the second retarder.

In one aspect of the present invention, a step of forming a plurality of opaque areas on a glass substrate comprises: using laser to radiate a surface of the glass substrate close to the quarter-wave plate to form the plurality of opaque areas.

In another aspect of the present invention, a step of forming a plurality of opaque areas on a glass substrate comprises: using laser to radiate the glass substrate to form the plurality of opaque areas within the glass substrate, and each opaque area couples to one of the plurality of black matrix layers.

In still another aspect of the present invention, a step of forming a plurality of opaque areas on a glass substrate comprises: photo etching a plurality of grooves on the glass substrate, and covering the plurality of grooves with opaque substances to form the plurality of opaque areas.

The advantage of the present invention is that the present invention provides a stereoscopic display device and a method for forming the same. The stereoscopic display device comprises a display panel, a quarter-wave plate and a glass substrate. The display panel comprises a plurality of left-eye pixel line units, a plurality of right-eye pixel line units and a color filter which comprising a plurality of filter units and a black matrix between any two of adjacent filter units. The quarter-wave plate comprises a plurality of a first retarder and a plurality of a second retarder. The glass substrate comprises a plurality of opaque areas, and each opaque area is disposed on the two adjacent first retarder and the second retarder and used for blocking the light from the right-eye pixel line units into the second retarder or the light from the left-eye pixel line units into the first retarder. Therefore, the light correspondent to the right-eye (or left-eye) signals is not obscured by the opaque areas even though users watch at a large view angle so that it improves crosstalk to optimize 3D image quality.

### BRIEF DESCRIPTION OF THE DRAWINGS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 1 illustrates a stereoscopic display device for displaying 3D images and a circularly polarized glasses according to the present invention.

FIG. 2 is a schematic diagram of the stereoscopic display device for displaying 3D images according to a preferred embodiment of the present invention.

FIG. 3 is a diagram that the assembly of the display panel, the polarizing plate, the glass substrate and the quarter-wave plate in FIG. 2 according to a first embodiment of the present invention.

FIG. 4 is a diagram that the assembly of the display panel, the polarizing plate, the glass substrate and the quarter-wave plate in FIG. 2 according to a second embodiment of the present invention.

FIG. 5 is a flowchart of a method of forming the stereoscopic display device 100 according a preferred embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

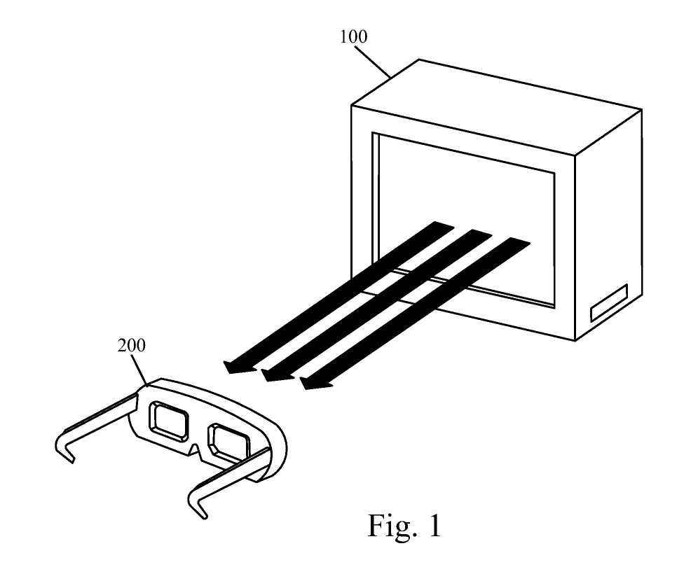

Please referring to FIG. 1, FIG. 1 illustrates a stereoscopic display device 100 for displaying 3D images and a circularly polarized glasses 200 according to the present invention. A user wearing the circularly polarized glasses 200 is capable of viewing 3D images when watching the stereoscopic display device 100.

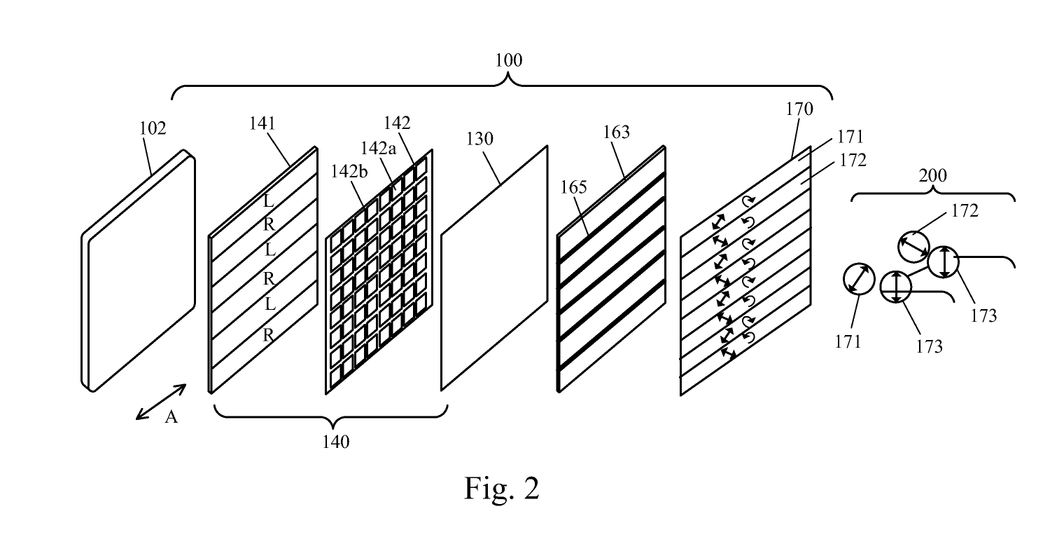

Please refer to FIG. 2. FIG. 2 is a schematic diagram of the stereoscopic display device 100 for displaying 3D images according to a preferred embodiment of the present invention. The stereoscopic display device 100 comprises a backlight module 102, a display panel 140, a polarizing plate 130, a glass substrate 163 and a quarter-wave plate 170. The backlight module 102 can be a direct-light type or a side-light-type backlight module which uses light emitting diodes (LEDs) or cold cathode fluorescent lamps (CCFLs) as light sources.

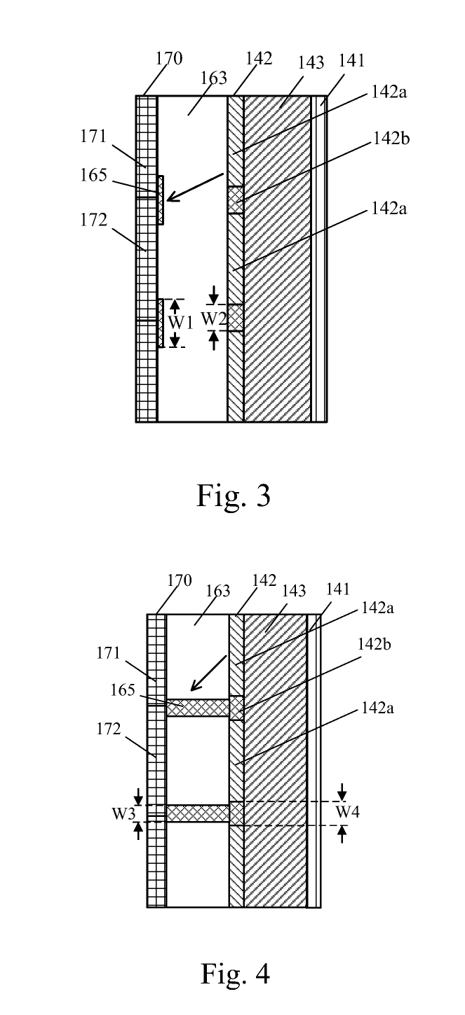

The display panel 140 comprises a pixel array 141 formed by a plurality of pixels, a color filter 142 and a liquid crystal layer 143 (shown in FIG. 3) sandwiched between the pixel array 141 and the color filter 142. Liquid crystal in the liquid crystal layer can be twisted nematic (TN), vertical alignment (VA) or in-plane-switching (IPS) liquid crystal. The pixel array 141 of the display panel 140 comprises a plurality of left-eye pixel line units L for displaying left-eye images based on left-eye signals and a plurality of right-eye pixel line units R for displaying right-eye images based on right-eye signals. The plurality of left-eye pixel line units L and the plurality of right-eye pixel line units R are arranged alternately in column direction. The color filter 142 comprises a filter unit 142a for displaying three primary colors, red, blue and green, and a black matrix layer 142b between any two of adjacent filter units 142a. It displays correspondent colors after light passing the filter unit 142a for displaying three primary colors, but the light is blocked by the black matrix layer 142b.

The polarizing plate 130 is set up at the emitting side of the display panel. The light produced by the backlight module 102 is emitted to the polarizing plate 130 through the display panel 140. The polarizing plate 130 has a transmission axis and an absorption axis orthogonal to the transmission axis. When the light through the display panel 140 emits to the polarizing plate 130, the light that its polarization direction is approximately parallel to the transmission axis of the polarizing plate 130 passes, and the light that its polarization direction is approximately parallel to the absorption axis is obscured. In this embodiment, the transmission axis of the polarizing plate 130 is perpendicular to a horizontal direction A. The light from the polarizing plate 130 is linearly polarized light at 90 degrees in the polarizing direction (perpendicular to the horizontal direction A). The quarter-wave plate 170 has a plurality of a first retarders 171 and a plurality of second retarders 172. The plurality of first retarders 171 and the plurality of second retarders 172 are arrange alternately in column direction. The angle between an optical axis of the first retarder 171 and the horizontal direction A is 135 degrees, and that between an optical axis of the second retarder 172 and the horizontal direction A is 45 degrees. The light from the right-eye pixel line units R becomes right-circularly polarized light after passing the polarizing plate 130 and the first retarder 171 of the quarter-wave plate 170, and the light from the left-eye pixel line units L becomes left-circularly polarized light after passing the polarizing plate 130 and the second retarder 172 of the quarter-wave plate 170.

The right-eye glasses of the circularly polarized glasses 200 comprises a first retarder 171 and a polarizer 173 whose a direction of the transmission axis perpendicular to the horizontal direction A, and the left-eye glasses of the circularly polarized glasses 200 comprises a second retarder 172 and a polarizer 173 whose the direction of the transmission axis perpendicular to the horizontal direction A. In hence, the left-circularly polarized light is capable of passing the left-eye glasses, and the right-circularly polarized light is capable of passing the right-eye glasses. In the embodiment, a user wearing the circularly polarized glasses 200 are capable of viewing left-eye images and right-eye images respectively by different eyes to perceive 3D images because the left-circularly polarized light and the right-circularly polarized light respectively correspond to the left-eye signals and the right-eye signals. Please referring to FIG. 3, FIG. 3 is a diagram that the assembly of the display panel, the polarizing plate, the glass substrate and the quarter-wave plate in FIG. 2 according to a first embodiment of the present invention. To prevent the viewing 3D effect from the crosstalk, a glass substrate 163, on which a plurality of opaque areas 165 are set up, is disposed between the quarter-wave plate 170 and the display panel 140. Each opaque area 165 adheres onto the adjacent first retarder 171 and second retarder 172 after the display panel 140, the glass substrate 163 and the quarter-wave plate 170 are assembled. Width of each opaque area 165 must be shorter than that of the right-eye pixel line unit R or the left-eye pixel line unit L. Each opaque area 165 locates at a side of the glass substrate 163 close to the quarter-wave plate 170. To avoid a decrease in the aperture rate of pixels due to an increase in width of the black matrix layer 142b, preferably, the width W1 of each opaque area 165 is larger than the width W2 of the black matrix layer 142b, and the opaque areas 165 are formed by laser directly radiating a surface of the glass substrate 163. The light correspondent to the right-eye (or the left-eye) signals just emit from the first retarders 171 (or the second retarders 172) because the width W1 of each opaque area 165 is larger than the width W2 of the black matrix layer 142b. The right-eye (or the left-eye) signals are obscured by the opaque areas 165 and not emitted through the second retarder 172 (or the first retarder 171) even though the user is in a sight of large viewing angle, thereby suppressing crosstalk to optimize 3D image quality.

Please refer to FIG. 4, FIG. 4 is a diagram that the assembly of the display panel, the polarizing plate, the glass substrate and the quarter-wave plate in FIG. 2 according to a second embodiment of the present invention. Compared with FIG. 3, opaque areas in FIG. 4 are formed within the glass substrate 163 by radiating with laser. Each opaque area 165 is within the glass substrate 163 and couples to the black matrix layer 142b, and a width W3 of the opaque areas 165 is narrower than a width W4 of the black matrix layer 142b. The light correspondent to the right-eye (or the left-eye) signals just emits from the first retarder 171 (or the second retarder 172) because the opaque areas 165 is within the glass substrate 163 and couple to the black matrix layer 142b. The right-eye (or the left-eye) signals are obscured by the opaque areas 165 and not emitted through the second retarder 172 (or the first retarder 171) even though the user is in a sight of large viewing angle, thereby suppressing crosstalk to optimize 3D image quality. The other way of forming the opaque areas 165 on the glass substrate 163 is that photo etching a plurality of grooves on the glass substrate 163 and then covering the grooves with opaque substances, such as metal.

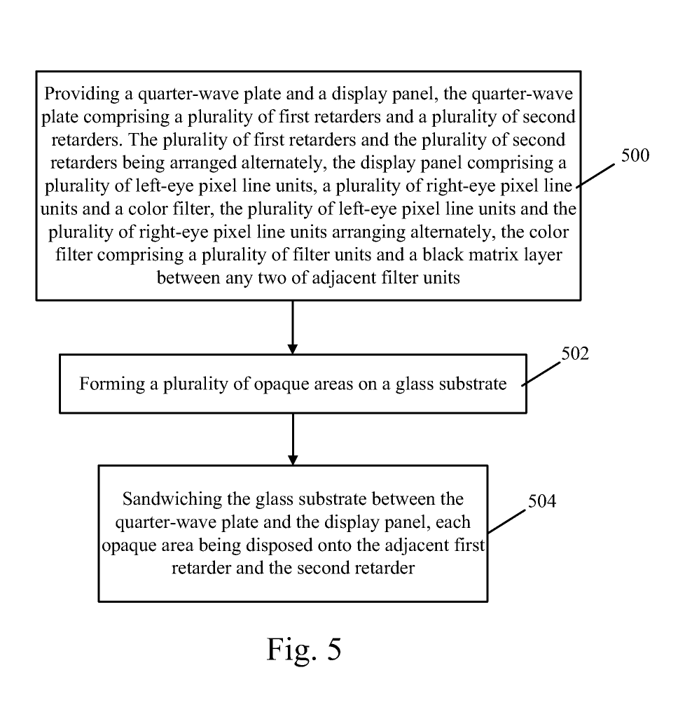

Please refer to FIG. 2 in conjunction with FIG. 5. FIG. 5 is a flowchart of a method of forming the stereoscopic display device 100 according a preferred embodiment of the present invention. The method comprises the following steps:

Step 500: providing the quarter-wave plate 170 and the display panel 140. The quarter-wave plate 170 comprises a plurality of first retarders 171 and a plurality of second retarders 172. The plurality of first retarders 171 and the plurality of second retarders 172 arrange alternately, and the angle between an optical axis of the first retarder 171 and that of the second retarder 172 is 90 degrees. The display panel 140 comprises the pixel array 141, the color filter 142 and the liquid crystal layer 143 between the pixel array 141 and the color filter 142. The pixel array 141 on the display panel 140 comprises a plurality of left-eye pixel line units L and a plurality of right-eye pixel line units R, and The plurality of left-eye pixel line units L and The plurality of right-eye pixel line units R arrange alternately. The color filter 142 comprises the filter unit 142a for displaying three primary colors, and the black matrix layer 142b between any two of adjacent filter units 142a.

Step 502: forming a plurality of opaque areas 165 on the glass substrate 163. One of the forming ways is that laser radiates the glass substrate 163 to form The plurality of opaque areas 165 on or within the glass substrate 163, and the other is photo etching a plurality of grooves on the glass substrate 163 and then covering the grooves with opaque substances, such as metal.

Step 504: sandwiching the glass substrate 163 between the quarter-wave plate 170 and the display panel 140. Each opaque area 165 is disposed onto the adjacent first retarder 171 and the second retarder 172. Each opaque area 165 can be on a surface of the glass substrate 163, which is at a side of the glass substrate 163 close to the quarter-wave plate 170, or can be within the glass substrate 163 and couples to the black matrix layer 142b.

Each opaque area 165 is capable of obscuring the light from the right-eye pixel line units R to the second retarder 172 or the light from the left-eye pixel line units L to the first retarder 171 by using the stereoscopic display device 100 manufactured in the above-mentioned way. The right-eye (or the left-eye) signals are obscured by the opaque areas 165 and not emitted through the second retarder 172 (or the first retarder 171) even though the user is in a sight of large viewing angle, thereby suppressing crosstalk to optimize 3D image quality.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A stereoscopic display device for displaying a 3D image comprising:
a backlight module for emitting light;
a display panel comprising a plurality of left-eye pixel line units, a plurality of right-eye pixel line units and a color filter, the plurality of left-eye pixel line units and the plurality of right-eye pixel line units being arranged alternately, the color filter comprising a plurality of filter units and a black matrix layer between any two of adjacent filter units;
a quarter-wave plate comprising a plurality of first retarders and a plurality of second retarders, the plurality of first retarders and the plurality of second retarders being arranged alternately, an angle between an optical axis of each first retarder and an optical axis of each second retarder being 90 degrees, and
a glass substrate between the display panel and the quarter-wave plate, the glass substrate comprising a plurality of opaque areas, and each opaque area onto the adjacent first retarder and the second retarder for obscuring light from the plurality of right-eye pixel line units to the plurality of second retarders or light from the plurality of left-eye pixel line units to the plurality of first retarders.

2. The stereoscopic display device of claim 1, wherein each opaque area forms on a surface of the glass substrate and locates at one side of the glass substrate close to the quarter-wave plate.

3. The stereoscopic display device of claim 2, wherein a width of each opaque area is larger than that of the black matrix layer.

4. The stereoscopic display device of claim 1, wherein each opaque area is within the glass substrate and couples to one of the plurality of black matrix layers.

5. The stereoscopic display device of claim 4, wherein a width of each opaque area is narrower than that of the plurality of black matrix layers.

6. The stereoscopic display device of claim 4 further comprising a polarizing plate, pasting on the display panel, for polarizing the light from the backlight module to a linearly polarized light.

7. A method of forming a stereoscopic display device comprising:
providing a quarter-wave plate and a display panel, the quarter-wave plate comprising a plurality of first retarders and a plurality of second retarders. The plurality of first retarders and the plurality of second retarders being arranged alternately, an angle between an optical axis of each first retarder and that of each second retarder is 90 degrees, the display panel comprising a plurality of left-eye pixel line units, a plurality of right-eye pixel line units and a color filter, the plurality of left-eye pixel line units and the plurality of right-eye pixel line units arranging alternately, the color filter comprising a plurality of filter units and a black matrix layer between any two of adjacent filter units;
forming a plurality of opaque areas on a glass substrate; and
sandwiching the glass substrate between the quarter-wave plate and the display panel, each opaque area being disposed onto the adjacent first retarder and the second retarder.

8. The method of claim 7, wherein a step of forming a plurality of opaque areas on a glass substrate comprises: using laser to radiate a surface of the glass substrate close to the quarter-wave plate to form the plurality of opaque areas.

9. The method of claim 7, wherein a step of forming a plurality of opaque areas on a glass substrate comprises: using laser to radiate the glass substrate to form the plurality of opaque areas within the glass substrate, and each opaque area couples to one of the plurality of black matrix layers.

10. The method of claim 7, wherein a step of forming a plurality of opaque areas on a glass substrate comprises:
photo etching a plurality of grooves on the glass substrate; and
covering the plurality of grooves with opaque substances to form the plurality of opaque areas.
